(19) United States
(12) Patent Application Publication
(10) Pub. No.: US 2025/0244878 A1
(43) Pub. Date: Jul. 31, 2025

(54) MEMORY DEVICE PAGE BUFFER MANAGEMENT

(71) Applicant: Micron Technology, Inc., Boise, ID (US)

(72) Inventors: Kapil Verma, San Jose, CA (US); Dheeraj Srinivasan, San Jose, CA (US); Chun Sum Yeung, San Jose, CA (US); Deping He, Boise, ID (US)

(21) Appl. No.: 19/034,003

(22) Filed: Jan. 22, 2025

Related U.S. Application Data
(60) Provisional application No. 63/626,691, filed on Jan. 30, 2024.

(51) Int. Cl. G06F 3/06

(52) U.S. Cl. CPC G06F 3/0613; G06F 3/0656; G06F 3/0679

(57) ABSTRACT

A memory device includes a memory array and control logic, operatively coupled to the memory array, to receive, from a memory sub-system controller, a command related to execution of a memory access operation associated with one or more memory blocks of the memory device. In response to the command, a portion of a page buffer of the memory device is reserved. The memory device causes at least a portion of non-host data received from a high-performance local memory of the memory sub-system controller to be stored in the portion of the page buffer.

### CROSS-REFERENCE TO RELATED APPLICATION

This application claims the benefit of U.S. Provisional Application No. 63/626,691, titled “Memory Device Page Buffer Management,” filed Jan. 30, 2024, the entire disclosure of which is incorporated herein by reference.

### TECHNICAL FIELD

Embodiments of the disclosure relate generally to memory sub-systems, and more specifically, relate to managing a page buffer of a memory device to improve data management efficiency in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1A illustrates an example computing system that includes a memory sub-system, in accordance with one or more embodiments of the present disclosure.

FIG. 1B is a block diagram of a memory device in communication with a memory sub-system controller of a memory sub-system, in accordance with one or more embodiments of the present disclosure.

FIGS. 2A-2D are schematics of portions of an array of memory cells as could be used in a memory of the type described with reference to FIG. 1B, in accordance with one or more embodiments of the present disclosure.

FIG. 3 is a block schematic of a portion of an array of memory cells as could be used in a memory of the type described with reference to FIG. 1B, in accordance with one or more embodiments of the present disclosure.

FIG. 4 illustrates an example memory sub-system including a memory device including a page buffer manager configured to manage a page buffer of the memory device, in accordance with one or more embodiments of the present disclosure.

FIG. 5 is a flow diagram of an example method to manage storage of data in a page buffer of a memory device, in accordance with some embodiments of the present disclosure.

FIG. 6 illustrates an example block diagram of an example computer system in which embodiments of the present disclosure may operate.

### DETAILED DESCRIPTION

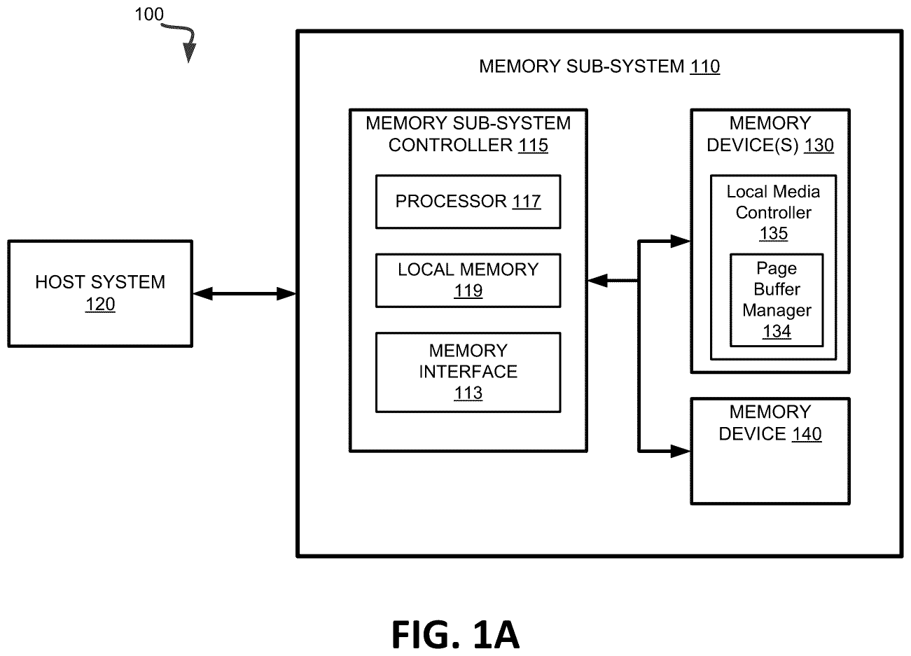

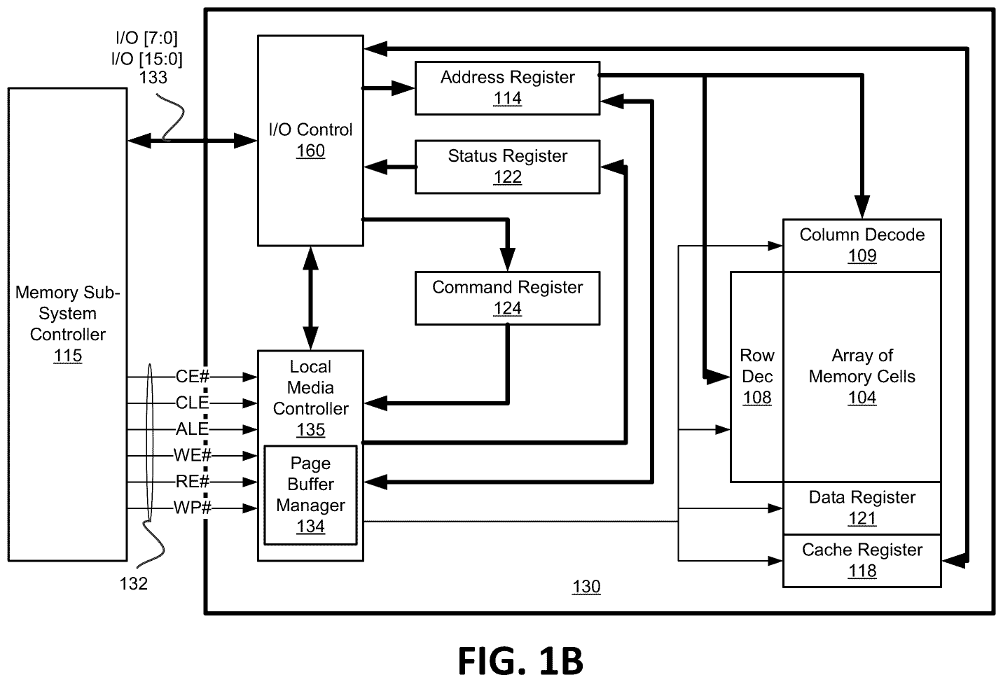

Aspects of the present disclosure are directed to management of a page buffer of a memory device to improve data management efficiency in a memory sub-system. A memory sub-system can be a storage device, a memory module, or a combination of a storage device and memory module. Examples of storage devices and memory modules are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1A. A non-volatile memory device is a package of one or more dies. Each die can include one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1,” or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can have a row of associated memory cells in a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

The one or more memory devices of a memory sub-system further include a page buffer used to store data being sensed from, or written to, the array of memory cells of the memory device. The page buffer may include a data register, a cache register, and sense circuitry. The page buffer, for example, may include sense circuitry connected to one or more conducting lines (e.g., one or more bitlines) of the array of memory cells that is configured to sense a change in voltage or current of the connected conducting lines (e.g., during a memory access operation). The voltage or current change that is sensed may be used to determine a binary value associated with a logical state of a selected memory cell connected to the conducting line. In some embodiments, the sense circuitry may be connected to each conducting line (e.g., each bitline) of the array of memory cells. In other embodiments, the sense circuitry may be selectively connected to a subset of conducting lines of the array of memory cells, for example, through a multiplexer. For instance, where a logical page of the array of memory cells includes every other conducting line, the multiplexer might connect every other conducting line (e.g., even or odd bitlines) to the sense circuitry. The output of the sense circuitry (i.e., the determined binary values) may be provided to data register, which may be configured to store the data.

Typical memory sub-systems including a memory sub-system controller configured to communicate with a host system to receive host data to be programmed to one or more memory devices. The memory sub-system controller includes a limited amount of high-performance local storage including internal static RAM (SRAM) memory. The local memory of the memory sub-system controller is configured to receive and store host data (e.g., data associated with one or more memory access operations relating to the memory array of one or more memory devices) (also referred to as “host data”) and other data relating to the operation, function, and management of the memory sub-system (herein referred to as “non-host data”). Example non-host data includes firmware variables, firmware code, etc.

The internal SRAM of the memory sub-system controller is tasked with supporting the full bandwidth of the backend and the host. However, although the SRAM supplies the highest bandwidth possible performance, such storage is limited and represents a high usage cost.

The page buffer of the memory device is used to store data being sensed from, or written to, the array of memory cells of the memory device. The page buffer may include a data register, a cache register, and sense circuitry. The page buffer, for example, may include sense circuitry connected to one or more conducting lines (e.g., one or more bitlines) of the array of memory cells that is configured to sense a change in voltage or current of the connected conducting lines (e.g., during a memory access operation). The voltage or current change that is sensed may be used to determine a binary value associated with a logical state of a selected memory cell connected to the conducting line. In some embodiments, the sense circuitry may be connected to each conducting line (e.g., each bitline) of the array of memory cells. In other embodiments, the sense circuitry may be selectively connected to a subset of conducting lines of the array of memory cells, for example, through a multiplexer. For instance, where a logical page of the array of memory cells includes every other conducting line, the multiplexer might connect every other conducting line (e.g., even or odd bitlines) to the sense circuitry. The output of the sense circuitry (i.e., the determined binary values) may be provided to data register, which may be configured to store the data.

In operation, both the high-performance local memory of the memory sub-system controller and the memory array(s) of the one or more memory devices store and manage the host data in one or more data structures (e.g., tables). The aforementioned limited size of the high-performance local memory (i.e., the SRAM) available for storing host data tables causes limitations in updating the host data residing in SRAM. For example, a system operation (e.g., a discard operation) may require a number of table data reads on static single level cells (SLC) blocks of the memory device to update the data stored in the SRAM via multiple corresponding SLC writes. As a result, the limited size of the SRAM requires multiple operations (e.g., multiple SLC reads and writes of a discard operation) to perform an updating of the host data stored in the SRAM. The limited allocation of SRAM for storing host data leads to inefficient and slow performance of the memory sub-system.

Aspects of the present disclosure address the above-identified and other deficiencies by managing a page buffer of one or more memory devices to store at least a portion of non-host data previously stored in a high-performance local storage (i.e., SRAM) of a memory sub-system controller. According to embodiments, a local media controller of a memory device includes control logic (herein referred to as a “page buffer manager”) to reserve at least a portion of the page buffer of the memory device for storing the non-host data transferred from the SRAM of the memory sub-system controller.

According to embodiments, reserving the portion of the page buffer includes modifying or setting one or more parameters associated with the identified page buffer portion to retain the stored non-host data (e.g., the non-host data previously written from the high-performance local memory of the memory sub-system controller) in response to enabling the page buffer reservation feature. Accordingly, once reserved, the non-host data stored in the reserved portion of the page buffer is not overwritten by a subsequent memory access operation associated with the memory device.

In an embodiment, the page buffer (also referred to as a data latch) of the memory device includes a set of multiple data latch circuits. According to embodiments, the page buffer manager can reserve a portion of the set of data latches to store non-host data transferred from the local memory (SRAM) of the memory sub-system controller.

Advantageously, storage of the non-host data in the reserved portion of the page buffer of the memory device frees up a corresponding portion of the high-performance local memory (i.e., SRAM) of the memory sub-system controller. Accordingly, the portion of the high-performance local memory that is freed up as a result of the off-loading of the non-host data to the reserved portion of the page buffer is able to store a larger amount of host data. Storage of a larger amount of host data in the high-performance local memory of the memory sub-system controller enables improved efficiency and performance in executing subsequent system operations (e.g., a discard operation).

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, compute express link (CXL) controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a CXL interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., one or more memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., one or more memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the one or more memory devices 130 can include one or more arrays of memory cells. One type of memory cell, for example, SLC can store one bit per cell. Other types of memory cells, such as multi-level cells (MLCs), triple level cells (TLCs), quad-level cells (QLCs), and penta-level cells (PLCs) can store multiple bits per cell. In some embodiments, each of the one or more memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the one or more memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the one or more memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

In an embodiment, the local media controller 135 includes at least a portion of a page buffer manager 134 and is configured to perform the functionality described herein. In an embodiment, the page buffer manager 134 can reserve a portion of a page buffer of the memory device 130 for storing non-host data received from a high-performance local memory (e.g., SRAM) of the memory sub-system controller 115. In an embodiment, the portion of the page buffer (also referred to as the “reserved portion of the page buffer”) identified and reserved by the page buffer manager 134 can be used to store non-host data (e.g., non-user data including firmware variables, firmware code, etc.).

According to embodiments, the page buffer manager 134 can reserve the portion of the page buffer for storing the non-host data in response to an action by a source external to the memory device 130. For example, the source external to the memory device 130 can be the memory sub-system controller 115. In an embodiment, in response to a request for the execution of an SLC operation (i.e., an operation associated with one or more SLC blocks of the memory device 130). Example SLC operations include an SLC read operation, an SLC program operation, an SLC erase operation, etc. In an embodiment, the memory sub-system controller 115 can enable the page buffer reservation feature using a Set Feature command. In an embodiment, the Set Feature command can modify a subfeature parameter at a feature address indicated by the Set Feature command. More specifically, a Set Feature command can be defined by a set of bits, and at least one bit of the set of bits can be used to indicate a portion of the page buffer is to be reserved in connection with an SLC operation associated with one or more SLC blocks of the memory device 130. Illustratively, a bit value of 1 can indicate a portion of the page buffer is to be reserved, and a bit value of 0 can indicate no portion of the page buffer is to be reserved.

In an embodiment, the memory sub-system controller 115 can enable the page buffer reservation feature using a trim option.

In another embodiment, the page buffer reservation feature can be enabled using a prefix command. More specifically, the prefix command may be sent by the memory sub-system controller 115 to the page buffer manager 134 when an SLC operation is be executed and reservation of a portion of the page buffer for storing non-host data is desired. Further details regarding page buffer manager 134 will be described below with reference to FIGS. 1B-5.

FIG. 1B illustrates an example simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), can be a memory controller or other external host device.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bit line). A single access line can be associated with more than one logical row of memory cells and a single data line can be associated with more than one logical column. Memory cells (not shown in FIG. 1B) of at least a portion of array of memory cells 104 are capable of being programmed to one of at least two target data states. In one embodiment, the array of memory cells 104 (i.e., a “memory array”) can include a number of sacrificial memory cells used to detect the occurrence of read disturb in memory device 130, as described in detail herein.

Row decode circuitry 108 and column decode circuitry 109 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 109 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, program operations and/or erase operations) on the array of memory cells 104. The local media controller 135 is in communication with row decode circuitry 108 and column decode circuitry 109 to control the row decode circuitry 108 and column decode circuitry 109 in response to the addresses.

The local media controller 135 is also in communication with a cache register 118. Cache register 118 latches data, either incoming or outgoing, as directed by the local media controller 135 to temporarily store data while the array of memory cells 104 is busy writing or reading, respectively, other data. During a program operation (e.g., write operation), data can be passed from the cache register 118 to the data register 121 for transfer to the array of memory cells 104; then new data can be latched in the cache register 118 from the I/O control circuitry 160. During a read operation, data can be passed from the cache register 118 to the I/O control circuitry 160 for output to the memory sub-system controller 115; then new data can be passed from the data register 121 to the cache register 118. The cache register 118 and/or the data register 121 can form (e.g., can form a portion of) a page buffer of the memory device 130. A page buffer can further include sensing devices (not shown in FIG. 1B) to sense a data state of a memory cell of the array of memory cells 104, e.g., by sensing a state of a data line connected to that memory cell. A status register 122 can be in communication with I/O control circuitry 160 and the local memory controller 135 to latch the status information for output to the memory sub-system controller 115.

Memory device 130 receives control signals at the local media controller 135 from the memory sub-system controller 115 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) can be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 134 and outputs data to the memory sub-system controller 115 over I/O bus 134.

For example, the commands can be received over input/output (I/O) pins [7:0] of I/O bus 134 at I/O control circuitry 160 and can then be written into command register 124. The addresses can be received over input/output (I/O) pins [7:0] of I/O bus 134 at I/O control circuitry 160 and can then be written into address register 114. The data can be received over input/output (I/O) pins [7:0] for an 8-bit device or input/output (I/O) pins [15:0] for a 16-bit device at I/O control circuitry 160 and then can be written into cache register 118. The data can be subsequently written into data register 121 for programming the array of memory cells 104.

In an embodiment, cache register 118 can be omitted, and the data can be written directly into data register 121. Data can also be output over input/output (I/O) pins [7:0] for an 8-bit device or input/output (I/O) pins [15:0] for a 16-bit device. Although reference can be made to I/O pins, they can include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B can not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) can be used in the various embodiments.

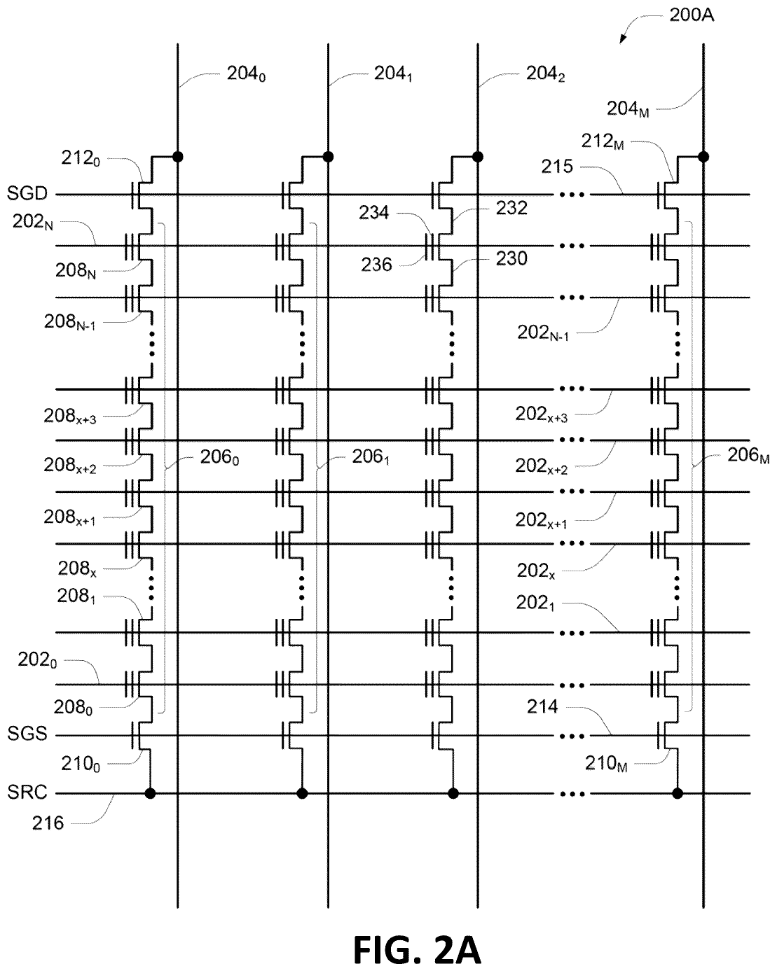

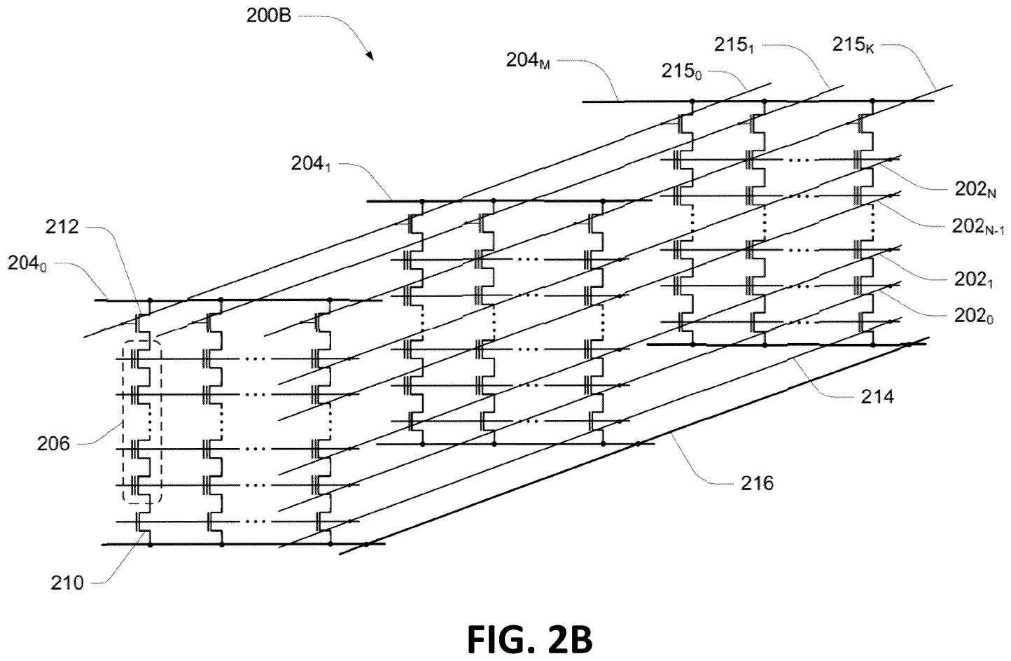

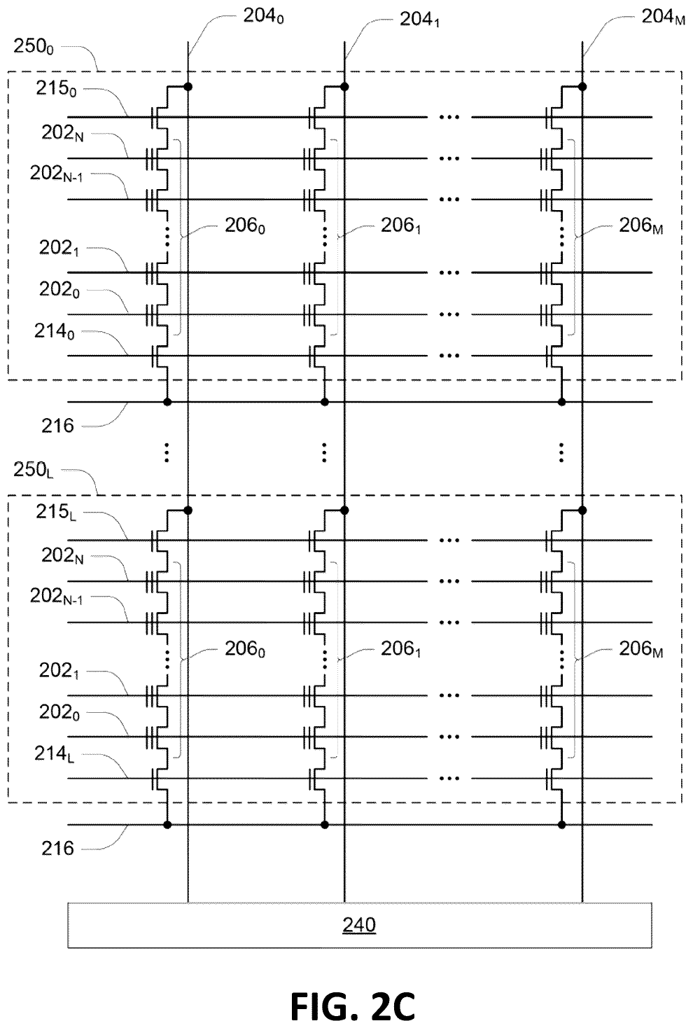

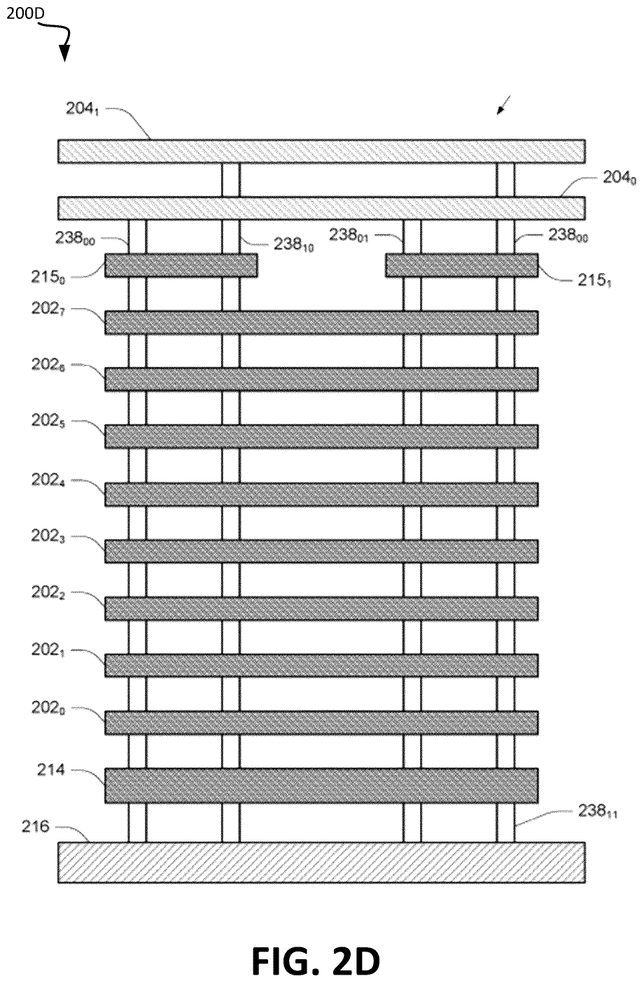

FIGS. 2A-2C are diagrams of portions of an example array of memory cells included in a memory device, in accordance with some embodiments of the present disclosure. For example, FIG. 2A is a schematic of a portion of an array of memory cells 200A as could be used in a memory device (e.g., as a portion of array of memory cells 104). Memory array 200A includes access lines, such as wordlines 202₀ to 202_{N}, and a data line, such as bitline 204. The wordlines 202 may be connected to global access lines (e.g., global wordlines), not shown in FIG. 2A, in a many-to-one relationship. For some embodiments, memory array 200A may be formed over a semiconductor that, for example, may be conductively doped to have a conductivity type, such as a p-type conductivity, e.g., to form a p-well, or an n-type conductivity, e.g., to form an n-well.

Memory array 200A can be arranged in rows each corresponding to a respective wordline 202 and columns each corresponding to a respective bitline 204. Rows of memory cells 208 can be divided into one or more groups of physical pages of memory cells 208, and physical pages of memory cells 208 can include every other memory cell 208 commonly addressable by a given wordline 202. For example, memory cells 208 commonly addressable by wordline 202_{N} and selectively connected to even bitlines 204 (e.g., bitlines 204₀, 204₂, 204₄, etc.) may be one physical page of memory cells 208 (e.g., even memory cells) while memory cells 208 commonly addressable by wordline 202_{N} and selectively connected to odd bitlines 204 (e.g., bitlines 204₁, 204₃, 204₅, etc.) may be another physical page of memory cells 208 (e.g., odd memory cells). Although bitlines 204₃-204₅ are not explicitly depicted in FIG. 2A, it is apparent from the figure that the bitlines 204 of the array of memory cells 200A may be numbered consecutively from bitline 204₀ to bitline 204_{M}. Other groupings of memory cells 208 commonly addressable by a given wordline 202 may also define a physical page of memory cells 208. For certain memory devices, all memory cells commonly addressable by a given wordline might be deemed a physical page of memory cells. The portion of a physical page of memory cells (which, in some embodiments, could still be the entire row) that is read during a single read operation or programmed during a single program operation (e.g., an upper or lower page of memory cells) might be deemed a logical page of memory cells. A block of memory cells may include those memory cells that are configured to be erased together, such as all memory cells addressable by wordlines 202₀-202_{N} (e.g., all strings 206 sharing common wordlines 202). Unless expressly distinguished, a reference to a page of memory cells herein refers to the memory cells of a logical page of memory cells.

Each column can include a string of series-connected memory cells (e.g., non-volatile memory cells), such as one of strings 206₀ to 206_{M}. Each string 206 can be connected (e.g., selectively connected) to a source line 216 (SRC) and can include memory cells 208₀ to 208_{N}. The memory cells 208 of each string 206 can be connected in series between a select gate 210, such as one of the select gates 210₀ to 210_{M}, and a select gate 212, such as one of the select gates 212₀ to 212_{M}. In some embodiments, the select gates 210₀ to 210_{M} are source-side select gates (SGS) and the select gates 212₀ to 212_{M} are drain-side select gates. Select gates 210₀ to 210_{M} can be connected to a select line 214 (e.g., source-side select line) and select gates 212₀ to 212_{M} can be connected to a select line 215 (e.g., drain-side select line). The select gates 210 and 212 might represent a plurality of select gates connected in series, with each select gate in series configured to receive a same or independent control signal. A source of each select gate 210 can be connected to SRC 216, and a drain of each select gate 210 can be connected to a memory cell 208₀ of the corresponding string 206. Therefore, each select gate 210 can be configured to selectively connect a corresponding string 206 to SRC 216. A control gate of each select gate 210 can be connected to select line 214. The drain of each select gate 212 can be connected to the bitline 204 for the corresponding string 206. The source of each select gate 212 can be connected to a memory cell 208N of the corresponding string 206. Therefore, each select gate 212 might be configured to selectively connect a corresponding string 206 to the bitline 204. A control gate of each select gate 212 can be connected to select line 215.

In some embodiments, and as will be described in further detail below with reference to FIG. 2B, the memory array in FIG. 2A is a three-dimensional memory array, in which the strings 206 extend substantially perpendicular to a plane containing SRC 216 and to a plane containing a plurality of bitlines 204 that can be substantially parallel to the plane containing SRC 216.

FIG. 2B is another schematic of a portion of an array of memory cells 200B (e.g., a portion of the array of memory cells 104) arranged in a three-dimensional memory array structure. The three-dimensional memory array 200B may incorporate vertical structures which may include semiconductor pillars where a portion of a pillar may act as a channel region of the memory cells of strings 206. The strings 206 may be each selectively connected to a bit line 204₀-204_{M} by a select gate 212 and to the SRC 216 by a select gate 210. Multiple strings 206 can be selectively connected to the same bitline 204. Groups of strings 206 can be connected to their respective bitlines 204 by biasing the select lines 215₀-215_{L} to selectively activate particular select gates 212 each between a string 206 and a bitline 204. The select gates 210 can be activated by biasing the select line 214. Each wordline 202 may be connected to multiple rows of memory cells of the memory array 200B. Rows of memory cells that are commonly addressable by each other by a particular wordline 202 may collectively be referred to as tiers.

FIG. 2C depicts groupings of NAND strings 206 into blocks of memory cells 250, e.g., blocks of memory cells 250₀-250_{L}. Blocks of memory cells 250 can be groupings of memory cells 208 that can be erased together in a single erase operation, sometimes referred to as erase blocks. Each block of memory cells 250 can represent those NAND strings 206 commonly associated with a single select line 215, e.g., select line 215₀. The source 216 for the block of memory cells 250₀ can be a same source as the source 216 for the block of memory cells 250_{L}. For example, each block of memory cells 250₀-250_{L} can be commonly selectively connected to the source 216. Access lines 202 and select lines 214 and 215 of one block of memory cells 250 can have no direct connection to access lines 202 and select lines 214 and 215, respectively, of any other block of memory cells of the blocks of memory cells 250₀-250_{L}.

The bitlines 204₀-204_{M} can be connected (e.g., selectively connected) to a buffer portion 240, which can be a portion of the page buffer 152 of the memory device 130. The buffer portion 240 can correspond to a memory plane (e.g., the set of blocks of memory cells 250₀-250_{L}). The buffer portion 240 can include sense circuits (which can include sense amplifiers) for sensing data values indicated on respective bitlines 204.

FIG. 2D is a diagram of a portion of an array of memory cells 200D (e.g., a portion of the array of memory cells 104). Channel regions (e.g., semiconductor pillars) 238₀₀ and 238₀₁ represent the channel regions of different strings of series-connected memory cells (e.g., strings 206 of FIGS. 2A-2C) selectively connected to the bitline 204₀. Similarly, channel regions 238₁₀ and 238₁₁ represent the channel regions of different strings of series-connected memory cells (e.g., NAND strings 206 of FIGS. 2A-2C) selectively connected to the bitline 204₁. A memory cell (not depicted in FIG. 2D) may be formed at each intersection of a wordline 202 and a channel region 238, and the memory cells corresponding to a single channel region 238 may collectively form a string of series-connected memory cells (e.g., a string 206 of FIGS. 2A-2C). Additional features might be common in such structures, such as dummy wordlines, segmented channel regions with interposed conductive regions, etc.

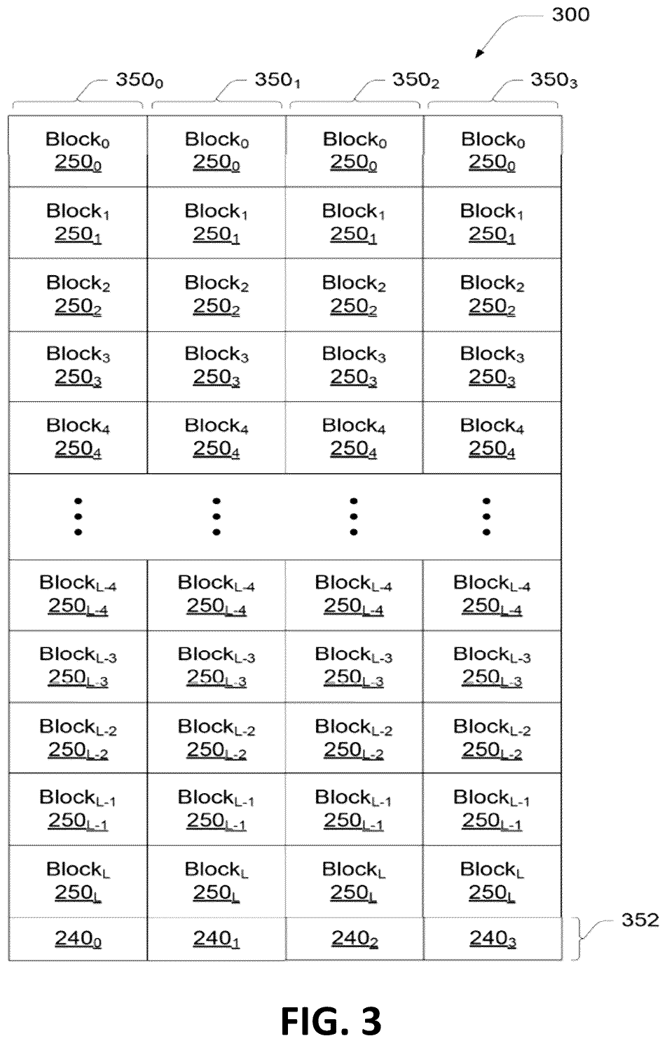

FIG. 3 is a block schematic of a portion of an array of memory cells 300 as could be used in a memory of the type described with reference to FIG. 1B. The array of memory cells 300 is depicted as having four memory planes 350 (e.g., memory planes 350₀-350₃), each in communication with a respective buffer portion 240, which can collectively form a page buffer 352. While four memory planes 350 are depicted, other numbers of memory planes 350 can be commonly in communication with a page buffer 352. Each memory plane 350 is depicted to include L+1 blocks of memory cells 250 (e.g., blocks of memory cells 250₀-250_{L}).

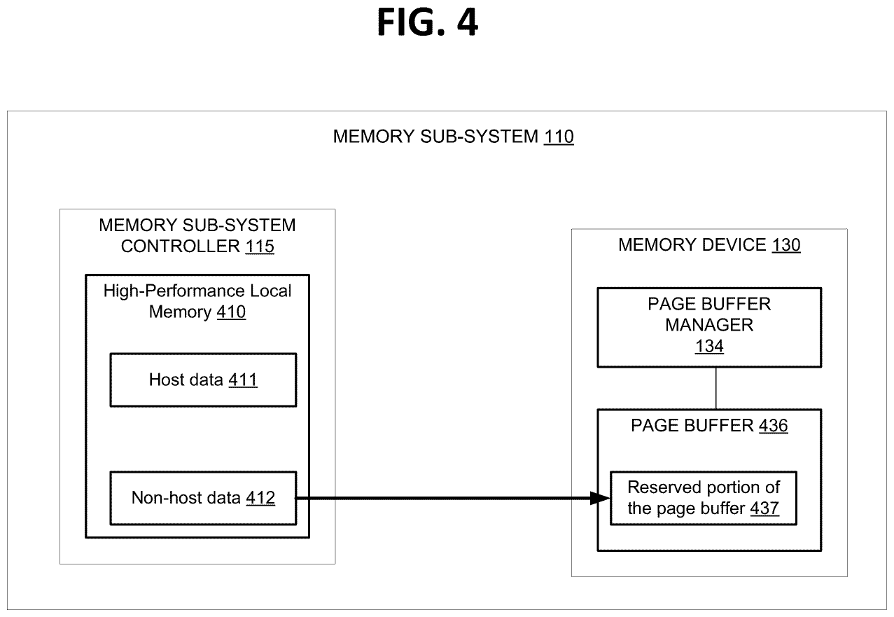

FIG. 4 illustrates an example memory sub-system 110 including a memory device 130 including a page buffer manager 134 configured to reserve a portion of a page buffer 436 to store non-host data 412 received from a high-performance local memory 410 of a memory sub-system controller 115, in accordance with one or more embodiments of the present disclosure. Advantageously, the reserving of the portion of the page buffer (i.e., the reserved portion of the page buffer 437) enables at least a portion of the non-host data 412 to be off-loaded by the memory sub-system controller 115, thereby freeing up additional storage capacity of the high-performance local memory 410 for storing host data 411 (e.g., host data associated with one or more requested SLC operations).

In an embodiment, the page buffer manager 134 is configured to enable a reserving operation with respect to the page buffer 436 in response to a command received from the memory sub-system controller 115 (e.g., a trim option, a Set Feature command, a prefix command, etc.). In an embodiment, the memory sub-system controller 115 can enable the page buffer reservation feature using a Set Feature command. In an embodiment, the Set Feature command can modify a subfeature parameter at a feature address indicated by the Set Feature command. More specifically, a Set Feature command can be defined by a set of bits, and at least one bit of the set of bits can be used to indicate a portion of the page buffer is to be reserved in connection with an SLC operation associated with one or more SLC blocks of the memory device 130. Illustratively, a bit value of 1 can indicate a portion of the page buffer is to be reserved, and a bit value of 0 can indicate no portion of the page buffer is to be reserved.

In an embodiment, the memory sub-system controller 134 can enable the page buffer reservation feature using a trim option.

In another embodiment, the page buffer reservation feature can be enabled using a prefix command. More specifically, the prefix command may be sent by the memory sub-system controller 115 to the page buffer manager 134 when an SLC operation is be executed and reservation of a portion of the page buffer for storing non-host data is desired.

In an embodiment, the memory sub-system controller 115 can receive a request from a host system to perform an SLC operation (e.g., a read operation, a program operation, or an erase operation associated with one or more SLC blocks of the memory device 130). In view of the SLC operation, the memory sub-system controller 115 can send a command to the page buffer manager 134 to enable the reservation of the portion of the page buffer 436. The page buffer manager 134 can, in turn, reserves a portion of the page buffer 436 (e.g., one or more data latch circuits) for storing non-host data 412 off-loaded from the high-performance local memory 410 (e.g., the SRAM) of the memory sub-system controller 115. Advantageously, the reserved portion of the page buffer 437 stores the off-loaded non-host data 412, which frees up additional capacity of the high-performance local memory 410 to be used to store a larger amount of host data 411. The storing of a larger amount of host data 411 in the high-performance local memory 410 of the memory sub-system controller 115 enables subsequent system operations (e.g., a discard operation) to be performed more efficiently.

In an embodiment, in response to the enabling of the feature, the page buffer manager 134 reserves a portion of page buffer 436 (e.g., one or more data latch circuits) of the memory device 130. In an embodiment, for example, for a memory device 130 having three or four data latch circuits, the page buffer manager 134 can reserve one data latch circuit to receive and store non-host data 412 that is off-loaded from the high-performance local memory 410 of the memory sub-system controller 115. Advantageously, use of one or more data latch circuits of the page buffer 436 to store non-host data 412 achieves an increase in the size of the useable portion of the high-performance local memory (i.e., SRAM) 410 for storing host data 411 by a significant amount (e.g., approximately 1.5MB to 3.0MB).

In an embodiment, after storing the non-host data 412 in the reserved portion of the page buffer 437, the memory sub-system 110 may execute a system operation (e.g., a discard operation where the user data that the host system wants to get rid of is discarded). For example, a system operation may be executed to discard previously written host data associated with logical block address (LBA) 0 to LBA 100. This discard operation involves the updating of the data structures (i.e., table updates) to discard the data residing in one or more SLC blocks of the memory device 130 and the corresponding data stored in the high-performance local memory 410 of the memory sub-system controller 115. Advantageously, in this example, the updates to the data structures of the high-performance local memory 410 can be executed more efficiently since a larger portion of the high-performance local memory 410 has been made available to store the host data 411 being updated as a result of the previous offloading of the non-host data 412.

According to embodiments, various methods can be used to initiate the reservation of the portion of the page buffer 436 by the page buffer manager 134. In some embodiments, enabling the page buffer reservation feature can be enabled by the page buffer manager 134 in response to receiving, from the memory sub-system controller 115. In some embodiments, the memory sub-system controller 115 can communicate the command to the page buffer manager 134 using a Set Feature command. The Set Feature command can be sent in connection with a request for the execution of an SLC operation (e.g., an SLC read, program, or erase operation). In an embodiment, a Set Feature command can be defined by a set of bits, and at least one bit of the set of bits can be used to indicate that a portion of the page buffer 436 is to be reserved for the off-loading of non-host data 412 from the high-performance local memory 410. For example, a bit value of 1 can indicate a command to reserve a portion of the page buffer 436, and a bit value of 0 can indicate that no page buffer portion reservation is to be performed. In some embodiments, the memory sub-system controller 115 can provide the page buffer manager 134 with a prefix command. More specifically, the prefix command may be sent by the memory sub-system controller 115 in connection with an SLC operation to cause the page buffer manager 134 to reserve a portion of the page buffer 436 for receiving and storing at least a portion of the non-host data 412. In an embodiment, the memory sub-system controller 115 can provide the page buffer manager 134 with a trim option to enable the page buffer reservation feature.

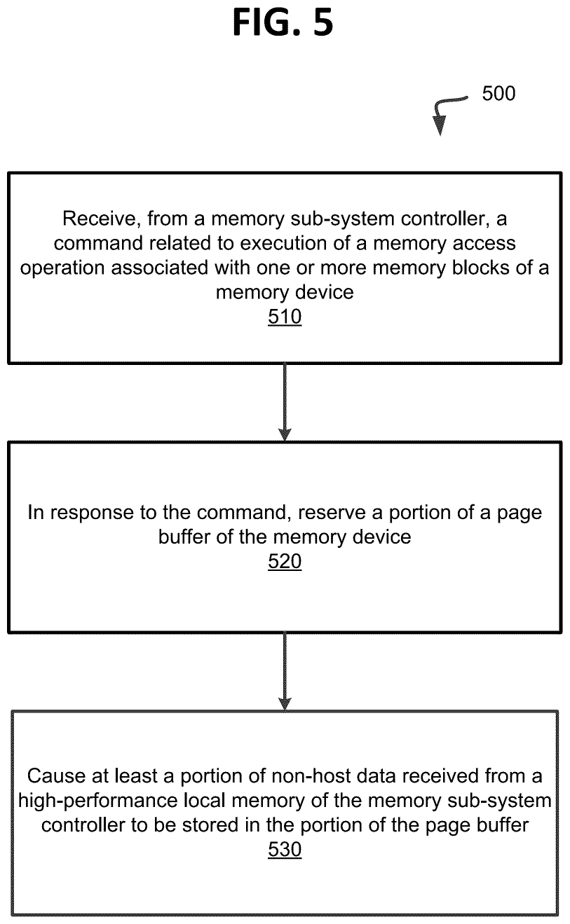

FIG. 5 illustrates a flow diagram of an example method 500 to reserve a portion of a page buffer of a memory device to store non-host data off-loaded from a high-performance local memory of a memory sub-system controller in a memory sub-system. Method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 500 is performed by the page buffer manager 134 of FIGS. 1A-B and 4. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, a command is received. For example, the processing logic (e.g., page buffer manager 134) at operation 510 can receive, from a memory sub-system controller, a command related to execution of a memory access operation associated with one or more memory blocks of a memory device. In an embodiment, the memory access operation includes an operation associated with one or more SLC blocks of the memory device. In an embodiment, the memory access operation includes an SLC read operation, an SLC program operation, an SLC erase operation, an SLC cache program operation, etc. In an embodiment, the command may include a trim option, a Set Feature command, or a prefix command.

At operation 520, an action is performed. For example, processing logic at operation 520 can, in response to the command, reserve a portion of a page buffer of the memory device. In an embodiment, the processing logic can identify the portion of the page buffer (e.g., one or more data latch circuits of the page buffer) to be reserved to store non-host data received from a high-performance local memory (e.g., SRAM) of the memory sub-system controller. In an embodiment, the one or more data latches are reserved by enabling any data stored in the reserved one or more latches to be overwritten by non-host data received from the high-performance local memory, as described in connection with operation 530. According to embodiments, reserving the portion of the page buffer includes modifying or setting one or more parameters associated with the identified page buffer portion to retain the stored non-host data (e.g., the non-host data previously written from the high-performance local memory of the memory sub-system controller) such that the non-host data stored in the reserved portion of the page buffer is not overwritten by a subsequent memory access operation associated with the memory device.

At operation 530, data is stored. For example, processing logic at operation 530 can cause at least a portion of non-host data received from a high-performance local memory of the memory sub-system controller to be stored in the portion of the page buffer. In an embodiment, the portion of the page buffer is reserved to receive and store non-host data (e.g., firmware variables, firmware code, etc.) off-loaded from the high-performance local memory (e.g., SRAM) of the memory sub-system controller. Advantageously, reserving a portion of the page buffer of the memory device to store non-host data received from the memory sub-system controller frees up a larger portion of the high-performance local memory (SRAM) of the memory sub-system controller to store a larger amount of host data in the high-performance local memory. By storing more host data in the high-performance local memory, subsequent system operations (e.g., a discard operation) can be performed to update the host data stored by the high-performance local memory.

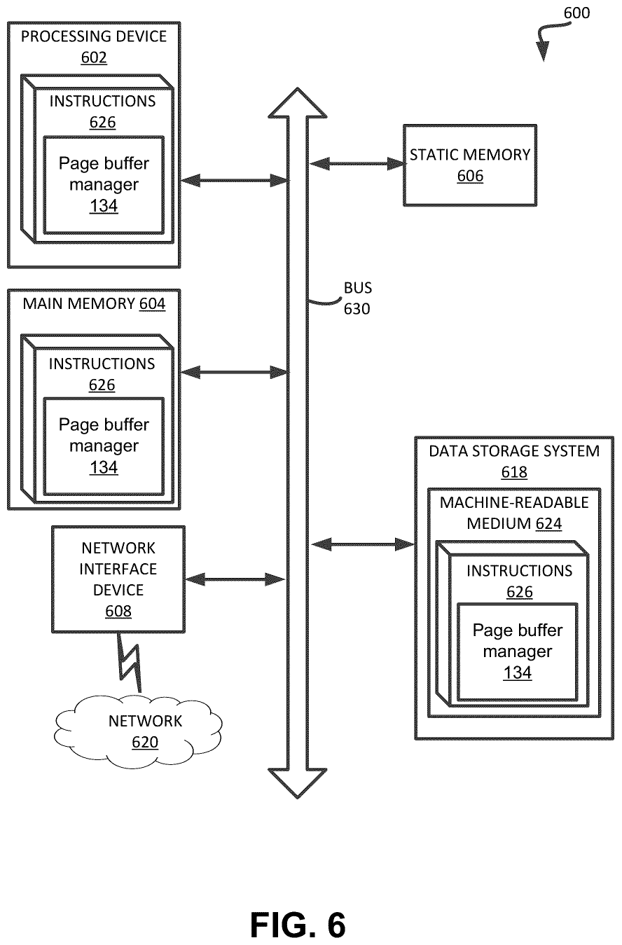

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to the debug operation manager of FIGS. 1A-B and 4). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1A.

In one embodiment, the instructions 626 include instructions to implement functionality corresponding to a block switch component (e.g., the page buffer manager 134 of FIGS. 1A-B and 4). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory device comprising:
a memory array;
a page buffer; and
control logic, operatively coupled to the memory array and the page buffer, to perform operations comprising:
receiving, from a memory sub-system controller, a command related to execution of a memory access operation associated with one or more memory blocks of the memory array of the memory device;
in response to the command, reserving a portion of the page buffer; and
causing at least a portion of non-host data received from a high-performance local memory of the memory sub-system controller to be stored in the portion of the page buffer.

2. The memory device of claim 1, wherein the memory access operation is associated with one or more single level cell (SLC) blocks of the memory device.

3. The memory device of claim 2, wherein the memory access operation comprises one of an SLC read operation, an SLC program operation, or an SLC erase operation.

4. The memory device of claim 1, wherein the non-host data comprises one or more of firmware variables or firmware code.

5. The memory device of claim 1, wherein the portion of the page buffer reserved to store the non-host data comprises one or more data latch circuits of the page buffer.

6. The memory device of claim 1, wherein the command comprises one of a Set Feature command, a prefix command, or a trim option.

7. The memory device of claim 1, wherein following causing the non-host data to be stored in the portion of the page buffer, additional host data is caused to be stored in the high-performance local memory of the memory sub-system controller.

8. A method comprising:
receiving, by a processing device from a memory sub-system controller, a command related to execution of a memory access operation associated with one or more memory blocks of a memory device;
in response to the command, reserving, by the processing device, a portion of a page buffer of the memory device; and
causing, by the processing device, at least a portion of non-host data received from a high-performance local memory of the memory sub-system controller to be stored in the portion of the page buffer.

9. The method of claim 8, wherein the memory access operation is associated with one or more single level cell (SLC) blocks of the memory device.

10. The method of claim 9, wherein the memory access operation comprises one of an SLC read operation, an SLC program operation, or an SLC erase operation.

11. The method of claim 8, wherein the non-host data comprises one or more of firmware variables or firmware code.

12. The method of claim 8, wherein the portion of the page buffer reserved to store the non-host data comprises one or more data latch circuits of the page buffer.

13. The method of claim 8, wherein the command comprises one of a Set Feature command, a prefix command, or a trim option.

14. The method of claim 8, wherein following the causing of the non-host data to be stored in the portion of the page buffer, additional host data is caused to be stored in the high-performance local memory of the memory sub-system controller.

15. A non-transitory computer-readable storage medium comprising instructions that, when executed by a processing device, cause the processing device to perform operations comprising:
receiving, from a memory sub-system controller, a command related to execution of a memory access operation associated with one or more memory blocks of a memory device;
in response to the command, reserving a portion of a page buffer of the memory device; and
causing, by the processing device, at least a portion of non-host data received from a high-performance local memory of the memory sub-system controller to be stored in the portion of the page buffer.

16. The non-transitory computer-readable storage medium of claim 15, wherein the memory access operation is associated with one or more single level cell (SLC) blocks of the memory device, and wherein the memory access operation comprises one of an SLC read operation, an SLC program operation, or an SLC erase operation.

17. The non-transitory computer-readable storage medium of claim 15, wherein the non-host data comprises one or more of firmware variables or firmware code.

18. The non-transitory computer-readable storage medium of claim 15, wherein the portion of the page buffer reserved to store the non-host data comprises one or more data latch circuits of the page buffer.

19. The non-transitory computer-readable storage medium of claim 15, wherein the command comprises one of a Set Feature command, a prefix command, or a trim option.

20. The non-transitory computer-readable storage medium of claim 15, wherein following the causing of the non-host data to be stored in the portion of the page buffer, additional host data is caused to be stored in the high-performance local memory of the memory sub-system controller.
